(19) United States
(12) Patent Application Publication
(10) Pub. No.: US 2003/0030674 A1
(43) Pub. Date: Feb. 13, 2003

(54) User interface for data acquisition

(76) Inventors: Helen Johnstone, Ipswich (GB); Andrew R Thompson, Ipswich (GB)

Correspondence Address: Nixon & Vanderhye, 8th Floor, 1100 North Glebe Road, Arlington, VA, 22201-4714, US

(21) Appl. No.: 10/221,215

(22) PCT Filed: Mar. 2, 2001
(86) PCT No.: PCT/GB01/00925

(30) Foreign Application Priority Data
Mar. 31, 2000 (GB) 0007886.5

(51) Int. Cl. G09G 5/00

(52) U.S. Cl. 345/781

(57) ABSTRACT

A method and apparatus is disclosed for providing a graphical user interface (GUI) system which is particularly but not exclusively useful in a client/server architecture. The GUI system is arranged in a manner that enables particular GUIs to be modified easily and for a single system to provide a plurality of GUIs each tailored to a particular task.

The present invention relates to user interfaces for use in data acquisition. The disclosed system is particularly but not exclusively useful in arrangements where a number of interfaces are being used to collect data.

One example of an arrangement where data is collected from a large number of sources is a field engineer management system. Such systems usually comprise a central server computer which receives data relating to tasks or jobs for individual field engineers to carry out. The server transmits the tasks to a portable terminal carried by the appropriate engineer thereby informing the engineer of the task and also enabling the engineer to enter reporting data about the task for use in the management system. Once the data has been entered by the engineer, normally when the task has been completed, a report is transmitted back to the server computer. The data can describe the timing of the task, whether it was successfully completed and if not why, the nature of any fault found, the parts used for the repair etc..

Commonly, such a management system is implemented using a client/server architecture, the server providing the functions related to the distribution of tasks and processing incoming task data while the client computers carried by the engineers are used for inputting data in response to the distributed tasks from the server. The client computer is normally equipped with a graphical user interface (GUI) that is structured to allow the engineer to enter the appropriated data for the assigned tasks.

The appearance of the GUI (which can also be referred to as a view) is governed by a view controller. The view controller also ensures that the elicited data is stored in a data structure (or data model). For each type of job carried out, a different set of data may need to be gathered. The view controller can be arranged to modify the format of the GUI in dependence on the type of job so as to allow input of only the appropriate data for storage in the data model. The view controller can also be arranged to respond to predetermined dependencies between individual data elements. For example, entry of one particular piece of data could change the allowable form or range of one or more other pieces of data.

GUIs, data models and their associated view controller are commonly constructed using an interface construction program or GUI Wizard. Using such a program the user specifies the appearance and behaviour of the GUI and the data to be captured and the system produces the GUI, data model and an appropriate view controller. These elements are then loaded into the client computer ready for use in data elicitation. If changes are required to data model or to the GUI's behaviour or appearance the specification process is repeated and the elements reloaded.

This system for producing a GUI, data model and associated view controller has a number of drawbacks. Firstly, the re-specification process is time consuming and expensive. Secondly, the GUI, data model and associated view are built to deal with all possible inputs in all situations i.e. they are relatively complex and bulky programs, especially as more flexibility is built into the interface.

According to an embodiment of the present invention there is provided an apparatus for providing a graphical user interface for the input or output of data, said interface comprising a plurality of sets of graphical elements which when two are more sets are displayed together provide the graphical user interface, each graphical element being arranged to provide a part of the graphical user interface for the input and/or output of an element of said data, said apparatus comprising:

a set of graphical element display instructions each associated with an element of the data; and

a plurality of view controllers each associated with a predetermined set of graphical element instructions,

the view controllers being independently operable in response to an instruction to display their associated set of graphical elements in accordance with the graphical element display instructions so as to provide said interface.

Embodiments of the invention alleviate the problems of the prior art. In particular, the task of re-specifying the interface is less complex since only individual view controllers need be changed. This results in a reduction in the size of the updated interface program that has to be downloaded because only the updated components of the system need to be transmitted to the client computers. Furthermore, during operation only those components that are necessary for a given task need to be run at any one time thereby tending to reduce the processing power required to run the interface for a particular task on the client computer. These advantages are particularly applicable when the client apparatus is of limited processing power and/or is connected to the sever apparatus via an expensive or low-bandwidth connection.

Embodiments of the present invention will now be described by way of example with reference to the accompanying drawings in which:

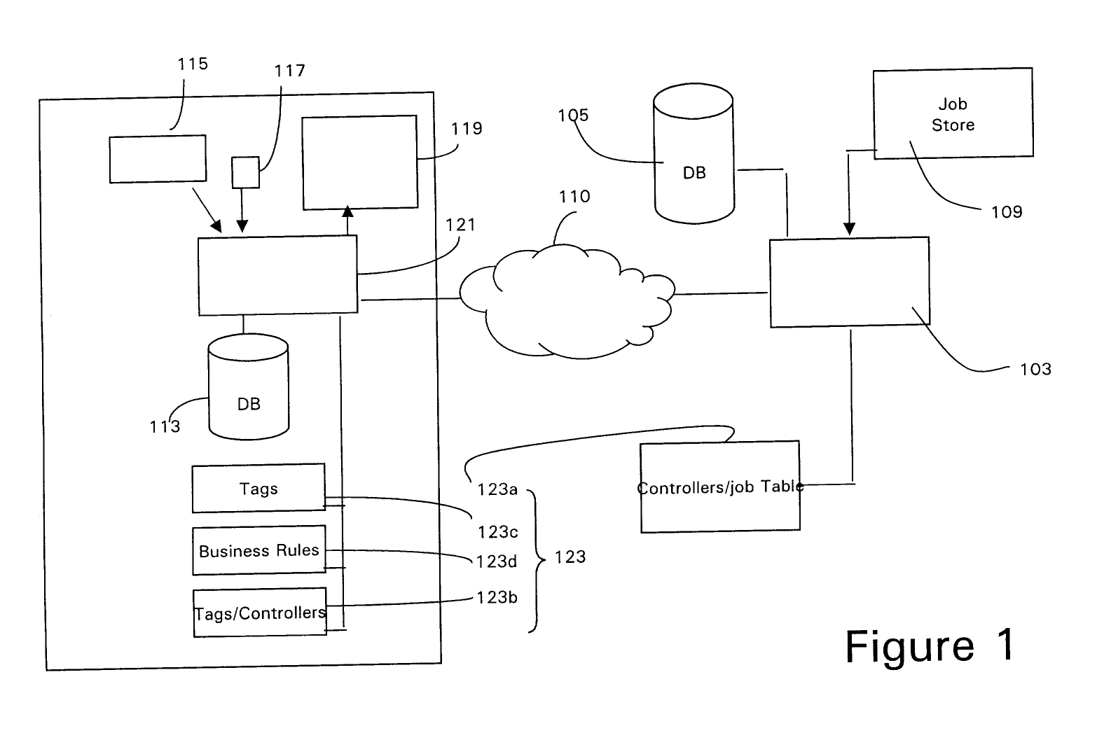

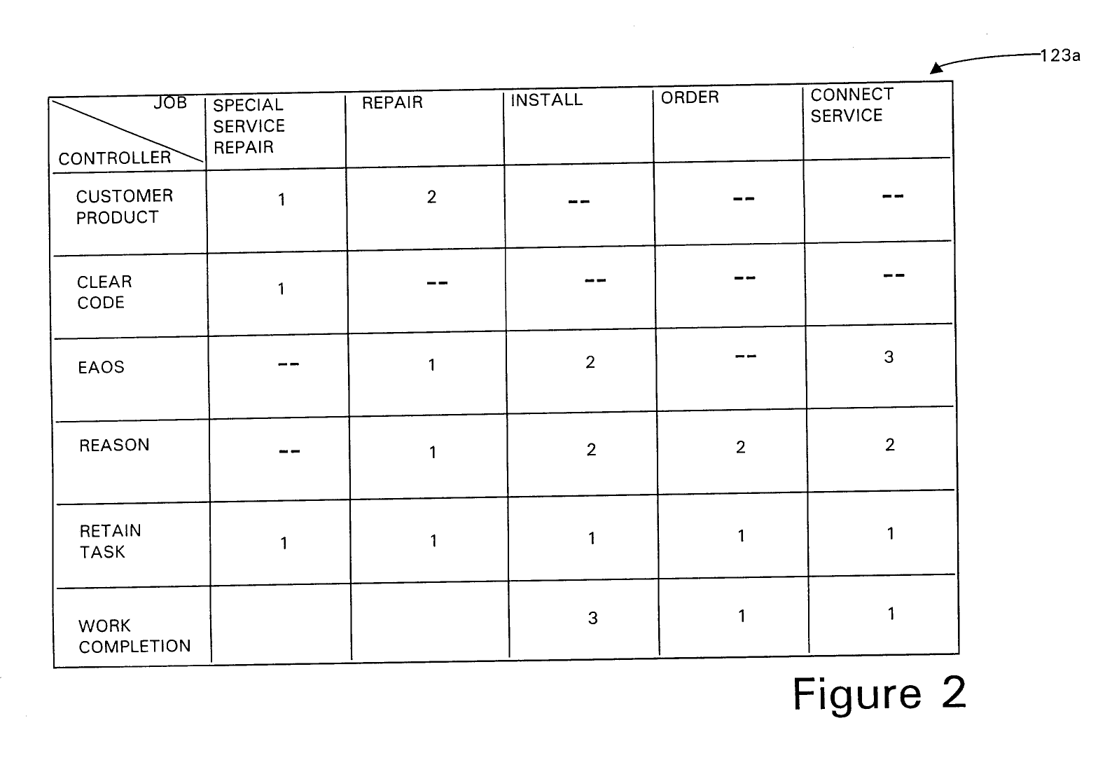

FIG. 1 is a schematic diagram of an management system embodying the invention;

FIGS. 2, 3, 4 and 5 are tables showing configuration data and instructions used in the management system of FIG. 1;

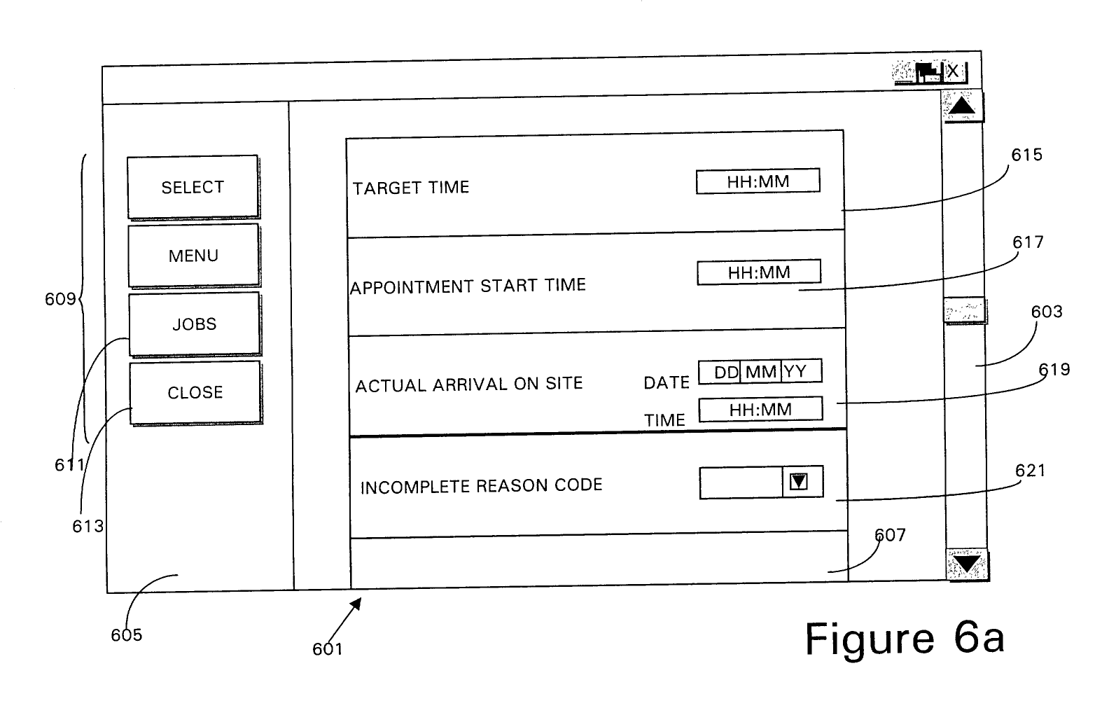

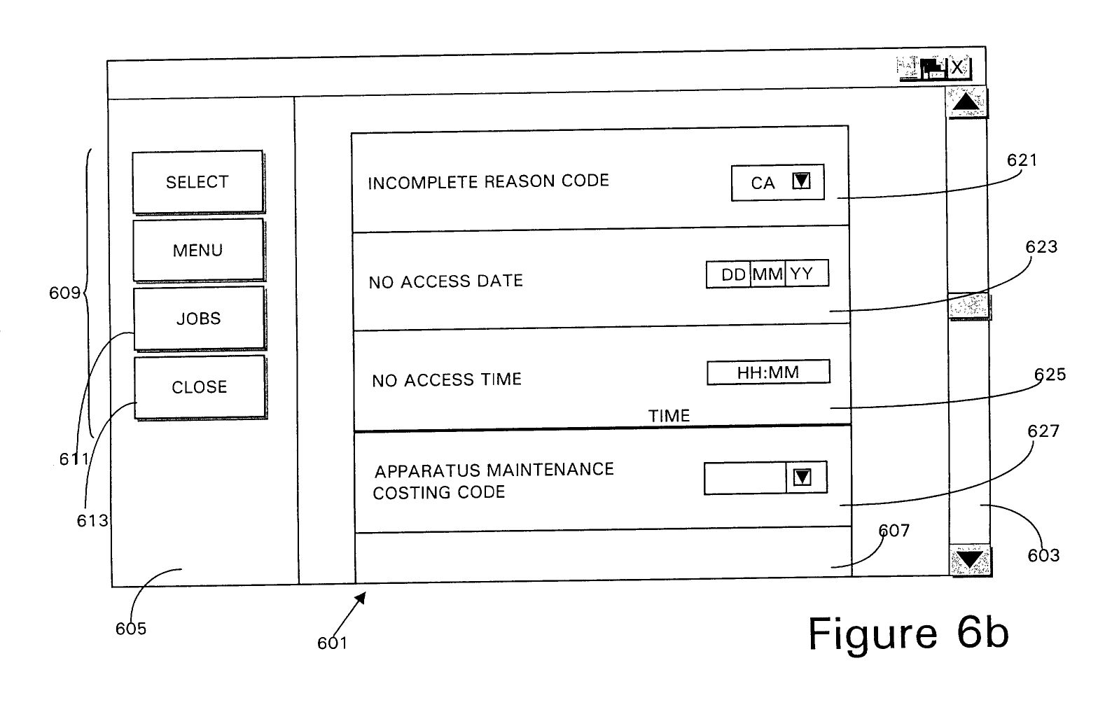

FIGS. 6a and 6b are diagrammatic representations of a view of an interface in use in the management system of FIG. 1; and

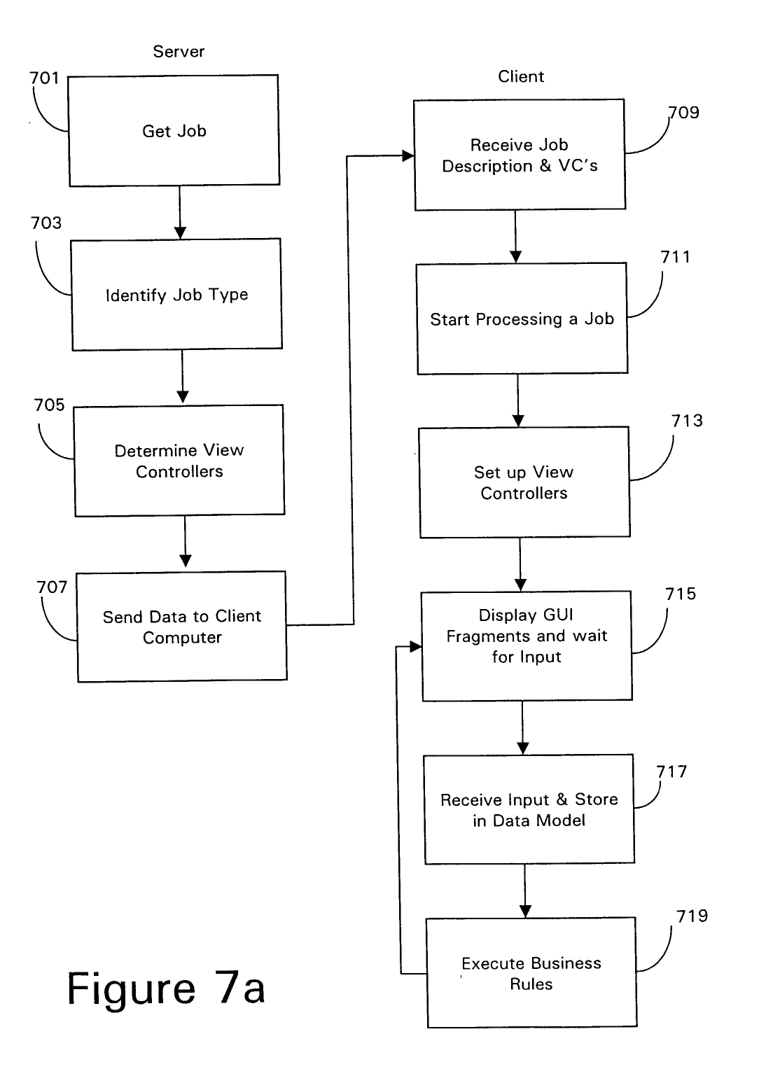

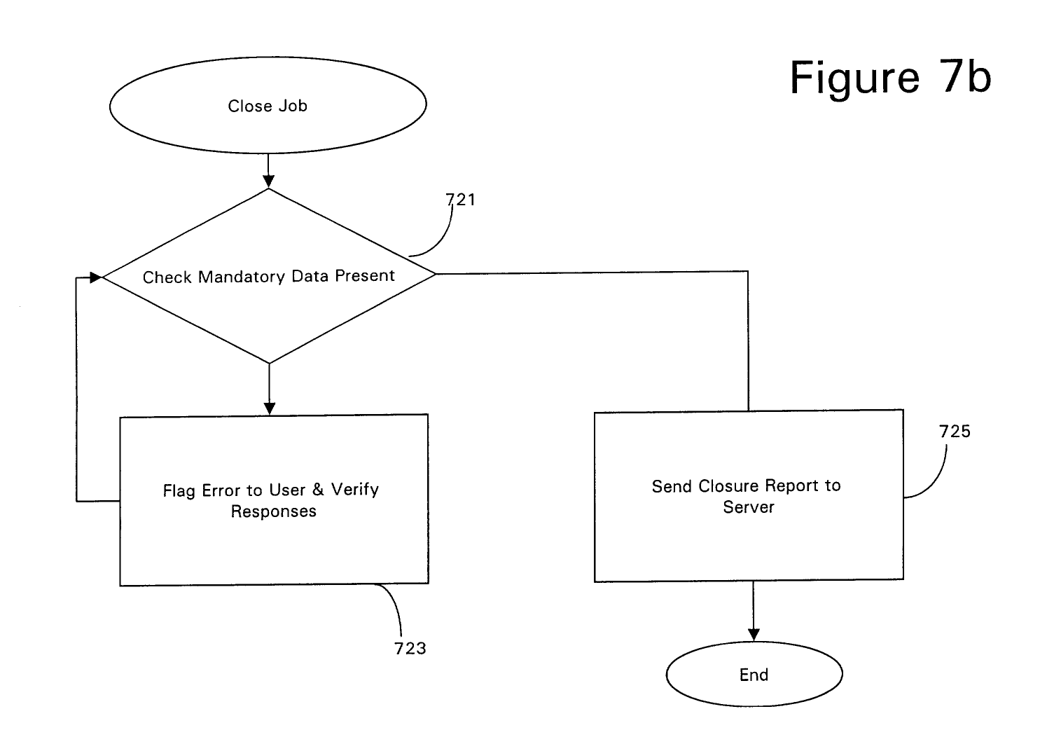

FIGS. 7a and 7b are control flow diagrams illustrating the operation of the interface in accordance with the instructions and data of FIGS. 2, 3, 4 and 5 to provide views of the type shown in FIGS. 6a and 6b.

FIG. 1 shows a management system 101 which in this embodiment is a field engineer support system that comprises a server computer 103 connected to a database 105 and a job store 107. The job store 107 is used to store details of jobs to be carried out by filed engineers while the database 105 is used to store data relating to completed jobs for passing on to a billing system or to the system from which a completed job originated (not shown).

The server computer 103 is connected via a network 110 to one or more client computers 111 (only one is shown if FIG. 1) which typically are carried by the field engineers. The connection between the server computer 103 and the or each client computer 111 may be via a fixed or mobile network connection. The client computer 111 is comprises data and program store 113, a keyboard 115, a mouse 117, a display 119 and a processor 121. Typically the client computer 111 is a laptop computer with the keyboard 115 and mouse 117 being used in combination with a GUI displayed on the display 119 to enable the elicitation of data. The form and behaviour of the interface is controlled by a view controller program run by the processor 121 and will be described in further detail below.

The system 101 also comprises a set of tables 123 which hold rules and data that govern the operation of the interface on the client computers 111. The contents and function of these tables will be described in detail with reference to FIGS. 2 to 5 below. One of the tables, the controllers/job table 123a is provided for use by the server computer 103 whereas the remaining tables, the tags/controller table 123b, the tags table 123c and the business rules table 123d are provided for use by the or each client computers 111.

FIG. 2 shows the controllers/job table 123a in detail. Each column of the table is headed by an identification of a category of job that the engineer could be expected to carry out (only a selection of possible jobs is shown). The first column is for a Special Service Repair i.e. the repair of equipment that requires different skill and possibly different equipment from a normal repair shown in the second column. The third column is for an installation job i.e. a job when new equipment is being provided to a customer where no equipment was present previously. The fourth column is for the order of equipment i.e. the provision of equipment to a customer that does not necessarily require any installation. The final column shown is for the connection of a service, in other words all necessary equipment present and already installed.

The left hand column of the controllers/job table 123a contains an entry for each view controller (only a selection are shown). Each view controller is responsible for controlling an element or section of the interface for eliciting a sub set of the data that needs to be collected for a given job. The controllers/job table 123a is designed to enable the system 101 to identify the view controllers that need to be used to collect data for each one of the jobs stored in the job store 107. The table of FIG. 2 shows six view controllers, a Customer Product view controller, a Clear Code view controller, an Engineer Arrival On Site (Eaos) view controller, a Reason view controller, a Retain Task view controller and a Work Completion view controller.

The view controllers that are applicable for each job are indicated by a number in the appropriate box of the table 123a. The numbers indicate which of one or more modes a given view controller should operate in for a particular job. In the present example, the view controllers may have up to three modes of operation, each mode being a variation applicable to one or more jobs. The operation of a view controller in its various modes will be explained in further detail below.

Referring to FIG. 2, it can be seen from the table that a Special Service Repair job requires the Customer Product, Clear Code and Retain Task view controllers all in mode one. The Repair job requires the Customer Product view controller in mode one and the EAOS, Reason and Retain Task view controllers all in mode one. The Install job requires the EAOS and Reason view controllers in mode two, the Retain Task view controller in mode one and the Work Completion view controller in mode three. The Order job requires the Reason view controller in mode two and the Retain Task and Work Completion view controllers in mode one. The Connect Service job requires the EAOS view controller in mode three, the Reason view controller in mode two and the Retain Task and Work Completion view controllers in mode one.

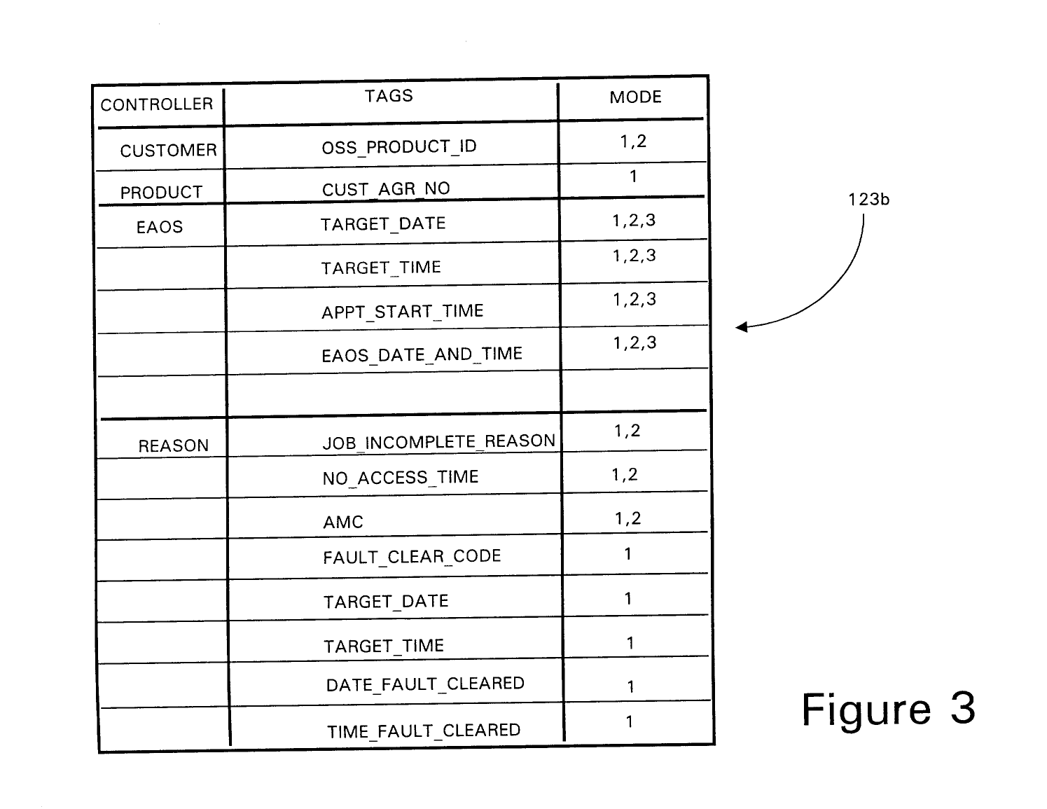

FIG. 3 shows the tags/controller table 1 23b. Tags are the term used to refer to the individual elements of data that are collected under the control of the view controllers and stored in the data model (the data model is the data structure used to store the collected data). Each view controller is associated with one or more tags as shown in FIG. 3, and in use, each view controller is arranged to enable the elicitation for each of the tags that it is associated with. In fact, a view controllers can be seen as general purpose program that is defined by the data it collects. In other words, it is the tags that a view controller is associated with that make it into a specific controller e.g. an Eoas or Reason view controller.

A view controller may be arranged to operate in one or more modes and may use different combinations of tags depending on the mode in which it is operating. The third column in the tags/controller table is used to indicate the modes in which each tag is used. For example, all the tags of the Eaos view controller are used in all three modes of that view controller. However, the Customer Product view controller only uses the Cust_Agr_No tag when operating in mode one (i.e. in a special service repair—see table 123a in FIG. 2).

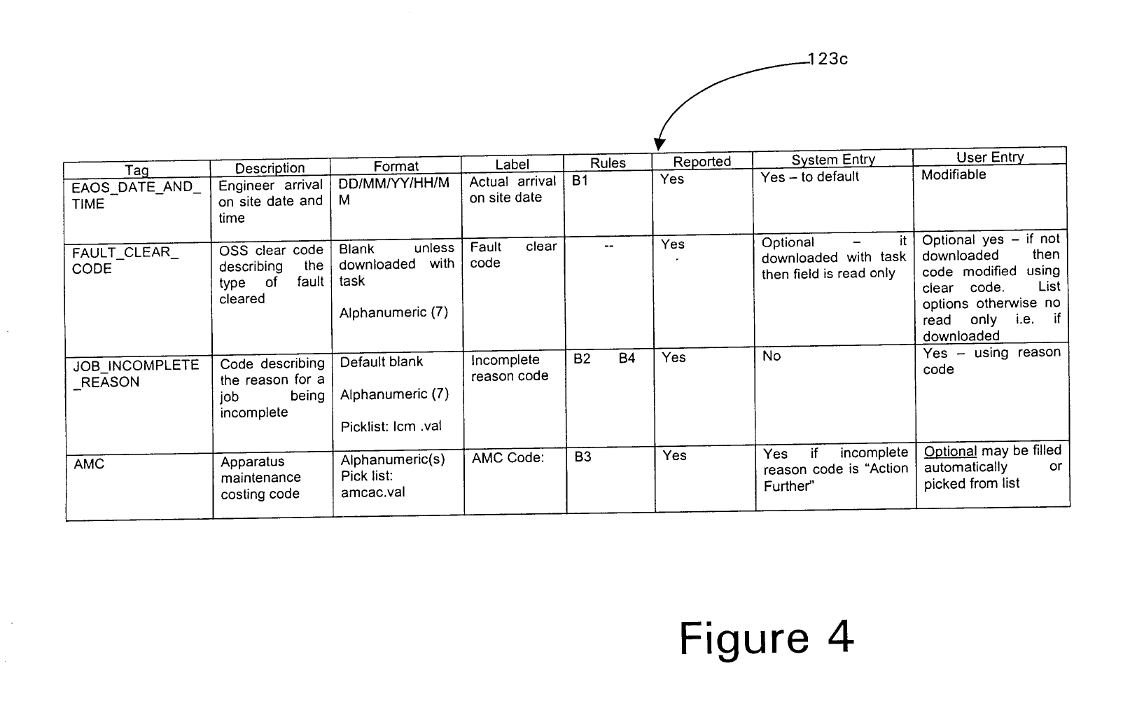

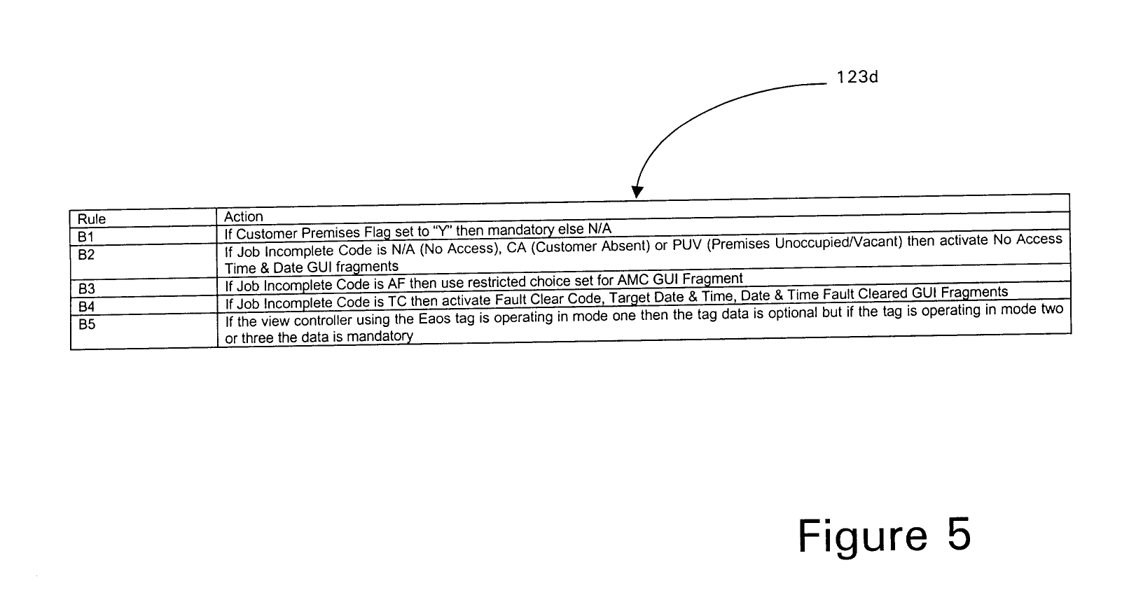

FIG. 4 shows the tags table 1 23c which has an entry for each of the tags in the system, the first column holds a description of the tags e.g. the first line of the table holds the entry for the tags named EAOS_DATE_AND_TIME which is described as the actual date and time that the engineer arrived on site. The entry also then describes the format in which the data for the corresponding tag should be entered i.e. day, month, year, hour and minute this corresponds to the form in which the data will be stored in the data model when it is received. Other tags may be a limited number of alphanumeric characters, free form text, a choice from a pick-list or a combination of these. The next entry in the table 123c is the label that will appear on the interface at the point at which the data should be entered by the engineer, the following entry refers to any rules that are relevant to the tag (these rules will be described further with reference to FIG. 5 below).

The Format and Label entries in the Tags table 123c are the part that are displayed in a part of the working GUI which is termed a GUI fragment. Each view controller treats each GUI fragment as a separate from the surrounding fragments. The group of GUI fragments that make up the interface for one view controller are referred to as a GUI element with one or more GUI elements making up the interface for a given job.

The next entry, the “Reported” column, determines whether or not the data associated with the tag is finally reported from the client to the management system or not i.e. taken from the data model and placed in a closure report. The following entry determines whether or not the associated data can be automatically entered by the system and if so can it be changed subsequently by the user. The last entry determines the conditions under which the data is modifiable by the user. Each view controller as noted above with reference to FIG. 3 is associated with one or more tags and is arranged to present each of its associated tags in the interface in the manner determined in the format and label columns of the tag table 123c. However, in some circumstances tags are only presented conditionally e.g. if data entered for another tag has a certain value or group of values. A tag may also be hidden from view in similar conditions.

FIG. 5 shows the business rules table 123d which has a left hand column of business rule labels which correspond to entries in the rules column of the tags table 123c. The right hand column of the business rules table 123d contains the rules themselves. The rules are used by the view controllers in response to entry by the user of data for a tag with which the rule is associated. In FIG. 5 the rules are represented in plain language for easy explanation but it will be appreciated that they would in fact be presented in a language that the view controllers could process.

Rule B1 is used by a view controller that uses the Eaos_Date_And_Time (EDAT) tag. If a piece of data in the data model called the Customer Premises Flag is set to “Y” the EDAT tag becomes mandatory (i.e. the report of the job cannot be returned to the operational support system until data is entered for this tag). Rule B2 is used by the view controller that uses the Job_Incomplete_Reason (JIR) tag and if the value chosen from the reason code pick list is one of three codes (NA, CA or PUV) this results in the activation of another tag in the view controller i.e. the No_Access_Date_And_Time tag will appear in the interface and accept data input from the user. Rule B3 results in a restriction being placed on the possible inputs to the Amc tag if what has already been put in to the Job_Incomplete_Code (JIC) tag is the code “AF”. Rule B4 is used when the code “TC” is entered in the JIC tag resulting in three other tags being made active namely Fault_Clear_Code, Target_Date_And_Time and Time_Fault_Cleared and revealed in the display to the user for data elicitation. Rule B5 is a rule that changes the behaviour of the Eaos tag depending on the mode in which the tag is operating with the result that the entry of the tag data is optional in mode one but mandatory (i.e. a report cannot be sent to the operational support system if the data is not entered) in modes two and three.

FIG. 6a shows a diagrammatic representation of an example of the interface as it appears on the display 119 to the user. The interface appears in a window 601 having the usual features such as scroll bars 603 and two frames 605, 607. The first frame 605 displays soft buttons 609 which perform various functions in the interface. For example, the button 611 marked “jobs” could present the user with a list of job details that have been downloaded to his client computer for action. The second frame 607 is used to display GUI fragments 615, 617, 619 and 621 in accordance with the instructions in the format and label columns of the tags table 123c. Although in the Figure, the GUI fragments 615, 617, 619 and 621 appear as separate boxes, they could also be displayed toghether in one box while still being treated as separate entities by the view controller. The contents of the second frame are in this example under the control of the Eaos and Reason view controllers which are displaying GUI fragments for the Target_Time, Appointment_Start_Time, Eaos and Incomplete_Reason tags (other GUI fragments may also display other tags and could be viewed by scrolling up or down in the frame 607).

FIG. 6b shows a diagrammatic representation of the same example of the interface 601 as FIG. 6a except after the entry of the code “CA” (meaning that the customer was absent) in the Incomplete_Reason_Code GUI fragment. As a result of the entry of this data the rule B2 from table 123c (and described above with reference to FIG. 5) has been activated resulting in the extra GUI fragments 623, 625, 627 shown in the second frame 609 being revealed. These extra GUI fragments 623, 625, 627 enable the elicitation of the extra data required as a result of the specific data being entered in the Incomplete_Reason_Code element of the data model via the GUI fragment 621.

If the value of the Incomplete_Reason_Code tag was altered to something other that “NA”, “CA” or “PUV” then the newly revealed GUI fragments 623, 625, 627 in FIG. 6b would be hidden or deactivated again. In other words, the rules can be used to activate or deactivate GUI fragments and their associated tags under the control of the appropriate view controller depending on the context i.e. the data that has been entered for other tags. This means that only the necessary tags displays i.e. ones which, in a given context, may be required and the interface is not cluttered with unnecessary GUI fragments for display.

The process by which a job entered in the job store 107 is processed by the management system will now be described with reference to the control flow diagrams of FIGS. 7a and 7b. At step 701, a server process accesses the job store 107 and obtains a job description and at step 703 identifies the job type in the job description. At step 705, the process uses the controllers/job table 123a to identify the relevant set of view controllers and their respective modes for processing the identified job. The identified list of view controllers and the job description are then sent to the relevant client computer 111 at step 707. If some of the data for the data model supplied by the management system then this is also send to the client computer 111. Also, if there is more than one job description in the job store 107 then these can all be processed as above before being sent as a batch to the client computer 111.

At step 709 in FIG. 7a, the client computer 111 receives the job description from the server computer 103. At step 711 in response to the selection of one of the jobs by the engineer using the soft-keys in the first frame 605, the process running on the client starts up the identified view controllers. At step 713 each of the view controllers uses the tags/controller table 1 23b to identify the tags to be displayed (depending on the view controller mode) and uses the tags table to determine the format and label to be used for the associated GUI fragments. At step 715, each of the GUI fragments are displayed in the second frame 609 of the interface to provide the whole GUI and the process waits for input from the user. When input is received then at step 717 the data is stored in the corresponding location in the data model. At step 719 any rules associated in the business rules table 123d are executed and if required the view controllers reveal or hide the appropriate GUI fragments. Processing then returns to step 715 to await further input.

Once the engineer believes that all the data necessary for a job has been entered then the close button in the first frame 603 can be used to close the job and to send a closure report to the support system 103. In response to this, at step 721 of FIG. 7b, the view controllers check every tag in use that is specified in the tag table 123c that its data field is mandatory (either via the system or entry columns or as a result of a business rule such as rule B5). If any of this data is missing then at step 723 the user is prompted to add the data. Once all mandatory data is present in the data model, it is packaged in a closure report and sent to the management system 103 at step 725. Once the report is sent the processing of the job by the client system is complete and the job description and associated data on the client 111 can be discarded.

As noted with reference to FIG. 1 above, the controllers/job table 123a is accessed by the server computer 103 and the tags/controller table 123b, tags table 123c and the business rules table 123d are accessed by the client computer 111. Indeed in the present embodiments, the tables are stored in the storage devices 105, 113 that access the respective tables 123.

On the server side, the controllers/job 123a can be edited to reconfigure the mode that a particular view controller operates in for a given job or even whether it is used for that job at all. This way the broad relationship between the job oriented function and the data elicitation function can be modified. Similarly, on the client side the tags/controller 123b can be modified to re-specify the modes in which tags become applicable in a given view controller. Furthermore, tags could be added to the functionality of a controller or removed altogether. In this manner the finer level of function of the interface can be modified and controlled. These changes could be made centrally and then transmitted to the client computers by way of instructions to edit the tags/controller table 123b.

The tags table 123c can also be modified to change any of the entries so as to affect changes at the fine detail of the interface including the format of the data stored in the data model and which data is reported to management system in the closure report. Also, the business rules table 1 23d can be modified to change the way that GUI fragments or elements interact and how data input for one tag can have an effect on the data for other tags. Again, these changes could be made centrally and then transmitted to the client computers by way of instructions to edit the tags table 123c or the business rules table 123d. As will be appreciated by those skilled in the art, although the table of the disclosed arrangement are functionally separated for ease of modification and update, there are still interdependencies such as some business rules and elements of the tags table 123c that need to be accounted for in any changes.

As noted above the above embodiment only a cross section of the possible tags, rules and view controllers have been show. The full system may include hundreds of tags and many more rules and view controllers.

Although the above embodiment shows a system in which data is mainly elicited from the user, the teachings of the present invention is equally applicable to presenting data in combination with elicitation or for presenting alone.

As will be understood by those skilled in the art, the hardware used to run the present invention is conventional. For example, the client computer could be a laptop pc with a GPRS mobile link to the server computer. The server computer may also be a standard machine with a database management system tailored to provide the functions of a management system. The system according to the invention will normally be embodied in software having elements running on the client and server computers to provide the client side interface, client/server communications and management system interfaces. The software may be written in any suitable language and may be particularly suited to object oriented implementation techniques.

As will be understood by those skilled in the art, any or all of the software used to implement the invention can be contained on various transmission and/or storage mediums such as a magnetic disc or tape , optical disc, or magneto-optical media so that the program can be loaded onto one or more general purpose computers or could be downloaded over a computer network using a suitable transmission medium.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. Apparatus for providing a graphical user interface for the input or output of data, said interface comprising a plurality of sets of graphical elements which when two are more sets are displayed together provide the graphical user interface, each graphical element being arranged to provide a part of the graphical user interface for the input and/or output of an element of said data, said apparatus comprising:
a set of graphical element display instructions each associated with an element of the data; and
a plurality of view controllers each associated with a predetermined set of graphical element instructions,
the view controllers being independently operable in response to an instruction to display their associated set of graphical elements in accordance with the graphical element display instructions so as to provide said interface.

2. Apparatus according to claim 1 in which said apparatus is operable to display one of a plurality of different graphical user interfaces, each interface being defined by a predetermined set of instructions for one or more view controllers.

3. Apparatus according to any preceding claim in which the instructions to the or each view controller are received by said apparatus from an instruction source over a communications link.

4. Apparatus according to any preceding claim in which each view controller has one or more modes of operation, the mode being determined in the instruction to the view controller and/or in dependence on the particular graphical user interface to be provided.

5. Apparatus according to any preceding claim in which one or more of said view controllers comprise one or more data dependent rules associated with a graphical element and arranged, in dependence on input data, to cause either display or remove from display of one or more other graphical elements.

6. A computer program or suite of computer programs arranged to enable a general purpose computer or other suitable processing device to provide the apparatus as set out in any of the preceding claims.
